(19) United States
(12) Patent Application Publication
(10) Pub. No.: US 2011/0121702 A1
(43) Pub. Date: May 26, 2011

(54) MOUNTING ARRANGEMENT FOR A FAN ASSEMBLY, REFRIGERATOR AND/OR FREEZER

(75) Inventors: Markus Köfele, Hopfgarten (AT); Richard Stocker, Lienz (AT)

(73) Assignee: Liebherr-Hausgerate Lienz GmbH, Lienz (AT)

(21) Appl. No.: 12/947,511

(22) Filed: Nov. 16, 2010

(30) Foreign Application Priority Data
Nov. 18, 2009 (DE) 10 2009 053 710.4
Dec. 22, 2009 (DE) 10 2009 060 078.7

(51) Int. Cl. F25D 23/00; F16M 13/00

(52) U.S. Cl. 312/401; 248/674

(57) ABSTRACT

A mounting arrangement for a fan comprising at least one mounting bracket and at least one fan, wherein the fan is latchable in the mounting bracket by means of at least one latching means. Also, assembly consisting of at least one counterpart; and at least one mounting arrangement, wherein in particular counterpart and mounting arrangement are latchable with each other, wherein the counterpart preferably is the appliance base of at least one of a refrigerator and a freezer and wherein the assembly preferably is the appliance base assembly of at least one of the refrigerator and the freezer.

### CROSS-REFERENCE TO RELATED APPLICATIONS

This Application claims priority to German Patent Application No. 10 2009 053 710.4, filed on Nov. 18, 2009 and German Patent Application No. 10 2009 060 078.7, Filed on Dec. 22, 2009. Those application are hereby incorporated by reference herein.

### BACKGROUND

1. Field of the Invention

Embodiments disclosed herein relate to a mounting arrangement for a fan, an assembly consisting of at least one counterpart and at least one mounting arrangement as well as a refrigerator and/or freezer and a mounting bracket.

2. Background Art

From the prior art, it is already known to arrange fans in the appliance base of a refrigerator and/or freezer, in order to achieve a directed airflow in the appliance base and to achieve for example cooling of components of the refrigerant circuit accommodated there, such as cooling of the compressor.

In the systems known so far it is provided that the fan is secured in a multi-part mounting bracket, in order to prevent for example lift-off of the fan from an intended position in the case of shocks. Such shocks can occur, for example, when the ventilator blade or fan blade strikes against adjoining parts or slightly touches the same. The disadvantage of multi-part mounting brackets, however, consists in that the same are costly and in addition involve an expensive assembly.

Alternatively, it has also been provided so far that the fan is held in a one-part receptacle, wherein such receptacles are not suitable to secure the fan against lift-off from its intended position in the case of shocks. Thus, it is possible that during lift-off of the fan noise is produced when the same strikes against adjoining parts or slightly touches the same with its fan blade.

Accordingly, there exists a need for fan mounting assemblies that resists lift-off and allows the fan to remain in its intended position in a mounting bracket.

### SUMMARY OF THE DISCLOSURE

In one aspect embodiments disclosed herein relate to a mounting arrangement for a fan comprising at least one mounting bracket and at least one fan, wherein the fan is latchable in the mounting bracket by means of at least one latching means.

In another aspect, embodiments disclosed herein relate to an assembly consisting of at least one counterpart; and at least one mounting arrangement, wherein in particular counterpart and mounting arrangement are latchable with each other, wherein the counterpart preferably is the appliance base of at least one of a refrigerator and a freezer and wherein the assembly preferably is the appliance base assembly of at least one of the refrigerator and the freezer.

Other aspects and advantages of the invention will be apparent from the following description and the appended claims.

### BRIEF DESCRIPTION OF DRAWINGS

FIG. 1 shows a perspective front view of the mounting arrangement in accordance with the invention.

FIG. 2 shows a perspective rear view of the mounting arrangement shown in

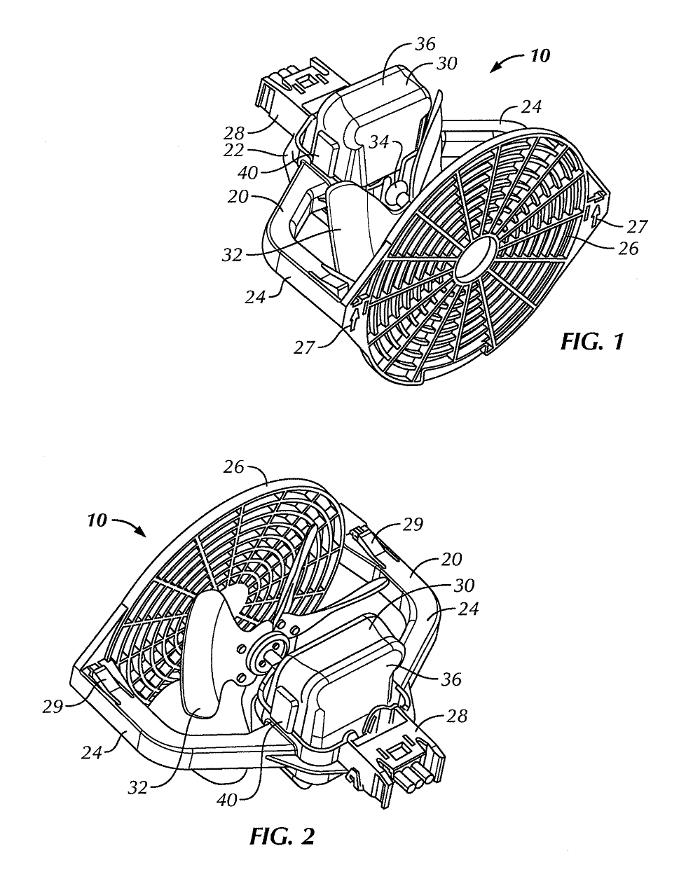

FIG. 1.

FIG. 3 shows a detailed representation of the mounting arrangement shown in

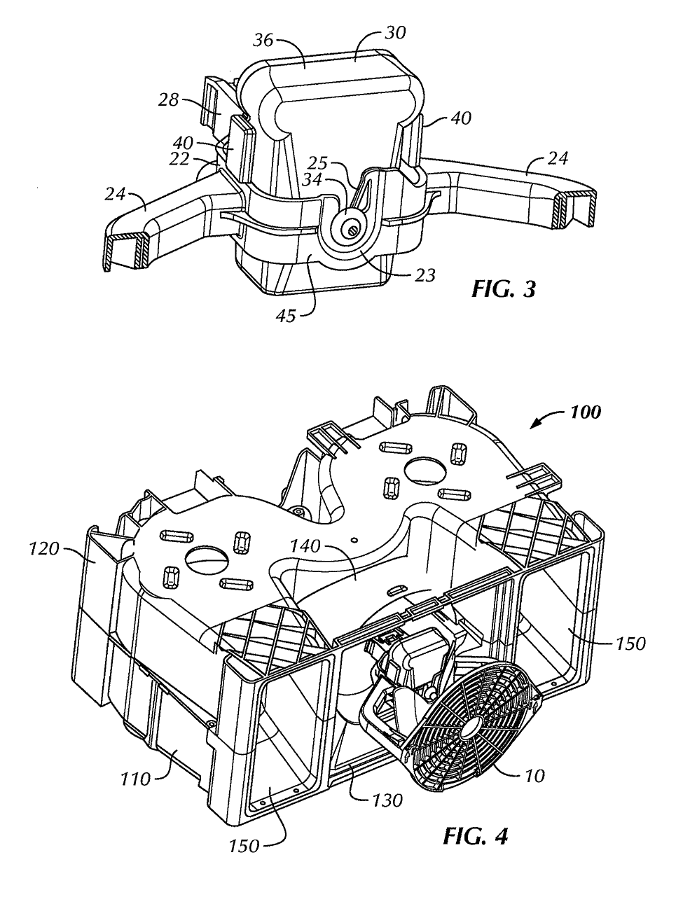

FIGS. 1 and 2.

FIG. 4 shows a perspective view of an assembly consisting of an appliance base of a refrigerator and/or freezer and of the mounting arrangement shown in FIGS. 1 to 3.

### DETAILED DESCRIPTION

In one aspect, embodiments disclosed herein relate generally to a mounting arrangement for a fan, an assembly consisting of at least one counterpart and at least one mounting arrangement as well as a refrigerator and/or freezer and a mounting bracket.

FIG. 1 shows a perspective front view of the mounting arrangement 10 for a fan 30 in accordance with the invention, wherein the fan 30 is inserted in the mounting bracket 20. The rear view of the mounting arrangement 10 is shown in FIG. 2.

The mounting bracket 20 is designed as a stirrup-shaped mounting bracket 20 which includes two symmetrical stirrup arms 24, which each are formed C-shaped proceeding from the push-in frame 22.

At the ends of the stirrup arms 24 a substantially circular covering grid 26 is integrally molded, by means of which a user is prevented from reaching into the region of the fan blade 32 during operation.

The fan blade 32 is arranged between the two stirrup arms 24 and the push-in frame 22 and the covering grid 26. The fan blade 32 is driven by the fan motor 36 of the fan 30, wherein the housing of the fan motor 36 is inserted into the push-in frame 22 of the mounting bracket 20.

The fan 30 includes a formation 34 which, as is shown in detail in FIG. 3, is inserted into a latching receptacle 23 on the side of the mounting bracket as part of the latching means 15. On the side of the mounting bracket, a latching hook 25 is provided, by means of which the fan-side formation 34 can be locked into place in the latching receptacle 23 on the side of the mounting bracket. To remove the motor 36 of the fan 30, the resiliently designed locking pawl 25 must merely be pressed in, in order to clear a fan-side formation 34, so that the same can be removed from the latching receptacle 23 on the side of the mounting bracket.

In the rear part of the mounting arrangement 10 or of the mounting bracket 20 a male connector part 28 is disposed, by means of which the energy supply of the fan or for the fan can be connected. When inserting the mounting arrangement 10 into a corresponding assembly or during connection with a corresponding counterpart, the connector 28 is put into a corresponding socket, so that the fan 30 thereby already is connected to its power supply.

For further fixation of the mounting arrangement 10, the same includes assembly latching means 29 at the ends of the stirrup arms 24 and covered by a part of the covering grid 26, by means of which the mounting arrangement 10 can be inserted into a corresponding counterpart 100 (cf. FIG. 4) and locked into place in the preassembled condition, i.e. with inserted fan 30. To simplify the assembly and avoid a wrong assembly, mounting aids 27 are provided, which, as shown in FIG. 1, for example can be embossed or imprinted arrows which indicate the correct mounting direction or arrangement.

To reduce vibrations between fan 30 and mounting bracket 20, damping means 40 are provided at the push-in frame 22 of the mounting bracket 20 on both narrow sides of the frame 22, which filter out and thereby attenuate the vibrations inevitably occurring in operation of the fan 30.

FIG. 4 shows a perspective view of the insertion of the mounting arrangement 10 shown in detail in FIGS. 1 to 3 into the appliance base 100 of a refrigerator and/or freezer, wherein the composed assembly of appliance base 100 and mounting arrangement 10 as well as possibly further components such as those of the compressor and parts of the condenser circuit is referred to as appliance base assembly.

The appliance base 100 includes two front-side openings 150, which can serve as air inlet, preferably also as air outlet. The appliance base 100 consists of a lower appliance base half 110 and an upper appliance base half 120, which for example can positively be put onto each other and/or can be screwed together. Both appliance base halves 110, 120 preferably can be injection-molded parts.

Between the two air inlet and outlet openings 150, a frame 130 is disposed, which opens the access to a recess 140. Into this opening 140, the mounting arrangement 10 is inserted and then locked into place inside the same by means of non-illustrated guide elements.

In these non-illustrated guide elements of the recess 140, in particular the assembly latching elements 29 of the mounting arrangement 10 are locked into place. In addition, the connector 28 is put into a socket provided in the recess 140 and not shown in detail in FIG. 4, so that the fan 30 is connected to the non-illustrated energy supply means of the appliance base 100.

In a particularly advantageous embodiment it is conceivable that the opening defined by the frame 130 serves as air inlet opening, whereas the openings 150 are air outlet openings of air guiding ducts arranged in parallel, which are charged with cold air by means of the fan 30, so that the components of the refrigerant circuit arranged in the air guiding ducts are cooled.

In accordance with the invention, problems associated with fan assemblies may be solved by a mounting arrangement for a fan with the features of claim 1. Accordingly, it is provided that a mounting arrangement for a fan comprises at least one mounting bracket and at least one fan, wherein the fan is latchable in the mounting bracket by means of at least one latching means. This involves the advantage that the fan with already mounted fan blade can simply be inserted into a mounting bracket from above. Due to the possibility of latching, the fan can quickly be fastened in the mounting bracket without any further fixing means, and due to the advantageous positive latching it is fixed in its position and secured against inadvertent lift-off from its position. Thus, the fan blade can effectively be prevented from striking against adjoining parts, which furthermore advantageously can avoid an unpleasant development of noise.

In addition, it can be provided that the latching means includes a latching receptacle on the side of the mounting bracket and a fan-side formation for insertion into the latching receptacle on the side of the mounting bracket. This involves the advantage of being able to create a particularly simple and at the same time efficient possibility for latching the fan in the mounting bracket. In particular, it can be provided that the fan includes at least one motor and at least one fan blade. It is conceivable to insert the fan with one of its components into the latching receptacle on the side of the mounting bracket and thereby lock the same into place. This can be achieved e.g. by inserting a part of the fan housing or housing of the motor of the fan into the mounting bracket.

Furthermore, it can be provided that the latching receptacle on the side of the mounting bracket includes a latching hook, wherein the latching hook is shiftable in particular by the insertion movement of the fan-side formation and wherein preferably the latching hook is automatically resetting upon insertion of the fan-side formation, so that the fan is secured against automatic release and/or that the latching receptacle on the side of the mounting bracket comprises a push-in frame and/or is part of a push-in frame. It is particularly advantageous when the latching hook is resilient and extends into a region of the latching receptacle on the side of the mounting bracket through which the fan-side formation is inserted into the latching receptacle on the side of the mounting bracket. For example, as a result of the insertion movement, the latching hook then can be pushed to the side and then is resetting automatically upon insertion of the fan-side formation into the latching receptacle on the side of the mounting bracket and thus fixes the fan-side formation.

Another advantage furthermore consists in that fan and mounting bracket also can again be separated from each other very easily, namely in that the latching hook clears the fan-side formation by being compressed, so that the same can be removed from the latching receptacle on the side of the mounting bracket. For example, the customer service can separate fan and mounting bracket from each other without any tool, in order to have unimpeded access for example to the fan motor or to be able to replace the same.

It can also be provided that the mounting bracket includes a covering grid which preferably is integrally molded to the mounting bracket and/or that the mounting bracket constitutes a U-shaped stirrup. The covering grid involves the advantage that it can be prevented that users can reach into the danger zone of the fan. Product safety thereby can be improved advantageously. Integral molding of the covering grid involves the advantage that mounting bracket and covering grid form one common component, which results in a simplified assembly due to a reduced number of parts of the components to be mounted. Preferably, the entire mounting bracket is formed in one piece.

It is preferred when the covering grid is integrally molded to the stirrup ends of the mounting bracket and/or that in the center of the stirrup the latching receptacle on the side of the mounting bracket is arranged. Particularly advantageously it is conceivable in this connection that the push-in frame for receiving the fan motor or the housing of the fan motor is provided in the center of the stirrup, wherein the latching receptacle on the side of the mounting bracket furthermore is arranged in the push-in frame. This involves the advantage that mounting bracket and fan only can be joined in one single predefined manner, which simplifies the assembly.

Furthermore, it can be provided that the mounting arrangement includes a plug means, by means of which the energy supply of the fan can be connected, wherein the plug means preferably is a socket or a connector for the power supply. This involves the advantage that the mounting arrangement, which can be inserted for example as a prefabricated assembly in a further larger assembly, simply can be plugged in. Separately connecting individual wires and power cables as well as control lines, which sometimes can be very laborious and prone to errors, thereby can advantageously be avoided. The plug means preferably can be standardized plug connections.

It can be provided that at least one damping means is provided, by means of which vibrations between fan and mounting bracket can be filtered out and/or attenuated and/or that the mounting arrangement includes at least one assembly latching means which serves to lock the mounting arrangement into place. The at least one damping means for example involves the advantage that the development of noise can further be reduced. In particular, it is possible to arrange two or more damping means symmetrically distributed between fan and mounting bracket, wherein it is conceivable that the damping means already are integrally molded to the mounting bracket, in particular to the push-in receptacle for the fan and e.g. partly sit on the housing of the fan motor or are in contact with the same.

In addition, this invention relates to an assembly with the features of claim 8. Accordingly, it is provided that an assembly consists of at least one counterpart and at least one mounting arrangement according to any of claims 1 to 7. In particular, it can be provided that the counterpart and the mounting arrangement are latchable with each other, wherein the counterpart preferably is the appliance base of a refrigerator and/or freezer and/or wherein the assembly preferably is the base assembly of a refrigerator and/or freezer. For locking the counterpart and the mounting arrangement into place, in particular the assembly latching means or the at least one assembly latching means of the mounting arrangement can be used, which are brought in engagement with corresponding mating latching means of the counterpart. It is particularly advantageous when upon locking counterpart and mounting arrangement into place, the plug means by means of which the energy supply of the fan can be connected is connected with the corresponding counterpart, so that the fan is at least indirectly connected to the energy supply means of the assembly.

Furthermore, the present invention relates to a refrigerator and/or freezer with the features of claim 9. Accordingly, it is provided that a refrigerator and/or freezer includes at least one mounting arrangement according to any of claims 1 to 7 and/or at least one assembly according to claim 8.

Furthermore, this invention relates to a mounting bracket for a fan with the features of claim 10. Accordingly, it is provided that a mounting bracket for a fan is designed with the mounting bracket features according to any of claims 1 to 7.

Further details and advantages of the invention will now be explained in detail with reference to an embodiment illustrated in the drawing.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A mounting arrangement for a fan comprising:
at least one mounting bracket and at least one fan, wherein the fan is latchable in the mounting bracket by means of at least one latching means.

2. The mounting arrangement of claim 1, wherein the latching means comprises a latching receptacle on the side of the mounting bracket and a fan-side formation for insertion into the latching receptacle on the side of the mounting bracket, the fan further comprising at least one motor and at least one fan blade.

3. The mounting arrangement of claim 2, wherein the latching receptacle on the side of the mounting bracket includes a latching hook. wherein the latching hook is shiftable in particular by the insertion movement of the fan-side formation and wherein the latching hook is automatically resetting upon insertion of the fan-side formation so that the fan is secured against automatic release and the latching receptacle on the side of the mounting bracket comprises a push-in frame and is part of a push-in frame.

4. The mounting arrangement of claims 1-3, wherein the mounting bracket comprises a covering grid which is integrally molded to the mounting bracket and the mounting bracket constitutes a U-shaped stirrup.

5. The mounting arrangement of claim 4, wherein the stirrup ends of the mounting bracket the covering grid is integrally molded and that in the center of the stirrup the latching receptacle on the side of the mounting bracket is arranged.

6. The mounting arrangement of claim 1-5, wherein the mounting arrangement comprises a plug means, by means of which the energy supply of the fan can be connected, wherein the plug means is a socket or a connector for the power supply.

7. The mounting arrangement of claim 1-4, wherein at least one damping means is provided, by means of which vibrations between fan and mounting bracket can be filtered out and attenuated and that the mounting arrangement includes at least one assembly latching means which serves to lock the mounting arrangement into place.

8. The mounting arrangement of claim 1, wherein the at least one mounting arrangement is disposed in at least one of a refrigerator and a freezer.

9. An assembly consisting of:
at least one counterpart; and
at least one mounting arrangement, wherein in particular counterpart and mounting arrangement are latchable with each other, wherein the counterpart preferably is the appliance base of at least one of a refrigerator and a freezer and wherein the assembly preferably is the appliance base assembly of at least one of the refrigerator and the freezer.

10. The assembly of claim 9, wherein the at least one mounting arrangement is disposed in at least one of a refrigerator and a freezer

11. A mounting bracket for a fan with the mounting bracket features according to any of claims 1 to 7.
